(19) United States
(12) Patent Application Publication
(10) Pub. No.: US 2026/0175301 A1
(43) Pub. Date: Jun. 25, 2026

(54) DRILL AND METHOD OF MANUFACTURING MACHINED PRODUCT

(71) Applicant: KYOCERA CORPORATION, Kyoto (JP)

(72) Inventor: Masahiko KURODA, Kyoto (JP)

(21) Appl. No.: 18/840,907

(22) PCT Filed: Feb. 7, 2023
(86) PCT No.: PCT/JP2023/003954

§ 371 Date: Aug. 23, 2024

(30) Foreign Application Priority Data
Feb. 24, 2022 (JP) 2022-026894

(51) Int. Cl. B23B 51/02; B23B 35/00

(52) U.S. Cl. CPC B23B 51/02; B23B 35/00

(57) ABSTRACT

There is a need for a drill capable of performing stable machining and having excellent chip dischargeability. A drill according to one aspect of the present disclosure includes a body extending along a rotational axis. The body includes a first outer peripheral surface, a first flute, and a second flute. The first outer peripheral surface includes a first margin, a second margin, and a first clearance. The first margin extends closer to a second end than the second margin, and the second margin includes a first region and a second region. A width of the second region in a circumferential direction about a rotational axis decreases from a first end toward the second end. The second flute includes a first portion and a second portion. A width of the second portion in the circumferential direction increases from the first end toward the second end.

### TECHNICAL FIELD

The present aspect relates to a drill and a method of manufacturing a machined product.

### BACKGROUND OF INVENTION

As a rotary tool used to perform milling on a workpiece, for example, drills disclosed in Patent Documents 1 and 2 are known. The drill described in Patent Document 1 has three or more margins on a land portion. Generally, providing a plurality of margins on an outer peripheral surface of the drill can reduce run-out during machining and enable stable machining.

In addition, a first margin connected to a flank face of a leading edge and a second margin positioned behind the first margin in a rotational direction are formed on an outer peripheral surface of the drill described in Patent Document 2. The second margin decreases in width in a circumferential direction about a rotational axis toward a rear end portion of a drill body.

### CITATION LIST

### Patent Literature

Patent Document 1: JP 2017-087406 A
Patent Document 2: JP 2006-281407 A

### SUMMARY

A drill according to an aspect of the present disclosure includes a rod-shaped body extending along a rotational axis from a first end toward a second end. The body includes a first outer peripheral surface extending from the first end toward the second end, a cutting edge positioned on the first end side, a first flute extending from the cutting edge toward the second end side and adjacent to the first outer peripheral surface forward in a rotational direction about the rotational axis, and a second flute extending from the cutting edge toward the second end side and adjacent to the first outer peripheral surface rearward in the rotational direction. The first outer peripheral surface includes a first margin extending along the first flute, a second margin extending along the second flute, and a first clearance positioned between the first margin and the second margin. The first margin extends closer to the second end than the second margin, and the second margin includes a first region positioned on the first end side and a second region positioned on the second end side with respect to the first region. A width of the second region in a circumferential direction about the rotational axis decreases from the first end toward the second end. The second flute has a first portion connected to the first region and a second portion connected to the second region. A width of the second portion in the circumferential direction increases from the first end toward the second end.

### BRIEF DESCRIPTION OF THE DRAWINGS

FIG. 1 is a perspective view illustrating a rotary tool of an embodiment.

FIG. 2 is an enlarged view of a region A1 illustrated in FIG. 1.

FIG. 3 is a plan view illustrating the rotary tool according to the embodiment.

FIG. 4 is a plan view of the rotary tool illustrated in FIG. 3 viewed from a B1 direction.

FIG. 5 is an enlarged view of a region A2 illustrated in FIG. 3.

FIG. 6 is a plan view of the rotary tool illustrated in FIG. 5 viewed from a B2 direction.

FIG. 7 is a cross-sectional view taken along line VII-VII illustrated in FIG. 5.

FIG. 8 is a cross-sectional view taken along line VIII-VIII illustrated in FIG. 5.

FIG. 9 is a cross-sectional view taken along line IX-IX illustrated in FIG. 5.

FIG. 10 is a schematic view illustrating a process of a method of manufacturing a machined product according to an embodiment.

FIG. 11 is a schematic view illustrating a process of the method of manufacturing a machined product according to the embodiment.

FIG. 12 is a schematic view illustrating a process of the method of manufacturing a machined product according to the embodiment.

### DESCRIPTION OF EMBODIMENTS

Hereinafter, a rotary tool according to an embodiment will be described in detail with reference to the drawings. Specifically, a drill as an example of a rotary tool will be described in detail with reference to the drawings. In addition to the drill, examples of the rotary tool include an end mill and a reamer. Accordingly, the drill described below may be replaced with another rotary tool such as an end mill.

In addition, in each of the drawings referred to below, for convenience of description, only main members among members constituting the embodiment are illustrated in a simplified manner. Accordingly, the drill may include any constituent member not illustrated in each drawing to which the present specification refers. Further, the dimensions of the members in each of the drawings do not faithfully represent the actual dimensions of the constituent members and the dimension ratios of each of the members.

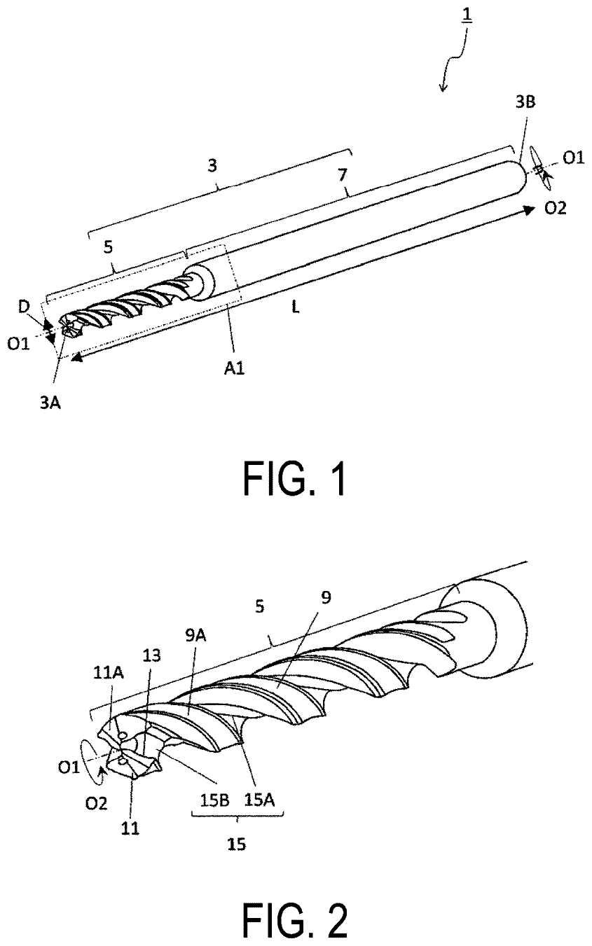

A drill 1 according to an embodiment of the present disclosure includes a rod-shaped body 3 extending along a rotational axis O1 from a first end 3A toward a second end 3B, as in the example illustrated in FIG. 1. The rod-shaped body 3 can rotate in a rotational direction O2 about the rotational axis O1 during workpiece machining for manufacturing a machined product.

In the example illustrated in FIG. 1, an end portion on a lower left side of the body 3 is the first end 3A, and an end portion on an upper right side is the second end 3B. In general, the first end 3A is also called a front end, and the second end 3B is also called a rear end. In the following description, the terms the front end 3A and the rear end 3B are used.

In the example illustrated in FIG. 1, the body 3 includes a cutting portion 5 positioned on the front end 3A side and a shank portion 7 positioned on the rear end 3B side with respect to the cutting portion 5. The cutting portion 5 includes a part that comes into contact with the workpiece, and this part plays a key role in machining the workpiece. The shank portion 7 is a part gripped by a rotating spindle or the like in a machine tool and may be designed according to the shape of the spindle. Examples of the shape of the shank portion 7 include a straight shank, a long shank, and a long neck.

An outer diameter of the body 3 of the embodiment may be set to, for example, 0.5 mm to 4 mm. In addition, when a length in a direction in which the rotational axis O1 extends is L and the outer diameter is D, in the body 3 of the embodiment, the relationship between L and D can be set to, for example, L=1D to 10D. In FIGS. 1 and 2, since an outer diameter of the shank portion 7 is larger than an outer diameter of the cutting portion 5, the outer diameter D may also be referred to as the outer diameter of the shank portion 7.

In the example illustrated in FIG. 2, the cutting portion 5 includes an outer peripheral surface 9, a front end surface 11, a cutting edge 13, and a flute 15. The outer peripheral surface 9 is positioned on an outer side from the front end 3A to the rear end 3B of the body 3. The cutting edge 13 is positioned on the front end 3A side of the body 3. Since the cutting edge 13 is generally called a front end blade, the cutting edge 13 may also be referred to as a front end blade. The flute 15 extends from the cutting edge 13 toward the rear end 3B side.

In the example illustrated in FIG. 4, the outer peripheral surface 9 is a surface region of the cutting portion 5 that is farthest from the rotational axis O1. The outer peripheral surface 9 may be at a generally constant distance from the rotational axis O1. Specifically, the distance from the rotational axis O1 to the outer peripheral surface 9 does not necessarily need to be constant. As described below, the outer peripheral surface 9 has a margin 27 and a clearance 31 whose distances from the rotational axis O1 slightly differ from each other. The distance from the rotational axis O1 to the outer peripheral surface 9 allows for differences in the distances from the rotational axis O1 at the margin 27 and the clearance 31.

The outer peripheral surface 9 is constituted by a plurality of surfaces separated from each other via the flute 15. When the outer peripheral surface 9 has a plurality of surfaces, one of the plurality of surfaces is referred to as a first outer peripheral surface 9A. When the first outer peripheral surface 9A is rotated about the rotational axis O1, the first outer peripheral surface 9A may overlap the outer peripheral surface 9 other than the first outer peripheral surface 9A. Specifically, in the example illustrated in FIG. 4, each outer peripheral surface 9 is 180° rotationally symmetric about the rotational axis O1.

The front end surface 11 is a surface positioned on the front end 3A side of the body 3. Specifically, on the front end 3A side, the front end surface 11 is positioned behind the cutting edge 13 in the rotational direction O2. As illustrated in FIG. 4, the front end surface 11 is a surface generally called a flank face, and may have a plurality of inclined flat surfaces or may have a curved surface shape. In addition, the front end surface 11 may have an opening portion 17 through which coolant is discharged. In this case, the coolant flows through a flow passage inside the body 3 and is discharged from the opening portion 17.

The body 3 has one or more front end surfaces 11. The number of front end surfaces 11 corresponds to the number of cutting edges 13. In the example illustrated in FIG. 4, the number of front end surfaces 11 and the number of cutting edges 13 are both two. When the body 3 has a plurality of front end surfaces 11, one of the plurality of front end surfaces 11 is referred to as a first front end surface 11A. When the first front end surface 11A is rotated about the rotational axis O1, the first front end surface 11A may overlap the front end surface 11 other than the first front end surface 11A. Specifically, in the example illustrated in FIG. 4, each front end surface 11 is 180° rotationally symmetric about the rotational axis O1.

As illustrated in FIG. 4, the cutting edge 13 includes a main cutting edge 19 extending from the rotational axis O1 side toward the outer peripheral surface 9 side. An end portion of the main cutting edge 19 on the outer peripheral surface 9 side is positioned on the rear end 3B side with respect to an end portion of the main cutting edge 19 on the rotational axis O1 side. The main cutting edge 19 refers to a portion of the cutting edge 13 that is positioned on a ridge line where the front end surface 11 and the flute 15 intersect with each other and at which a rake angle has a positive value.

When the body 3 is viewed from the front end 3A side in a front view as in the example illustrated in FIG. 4, the cutting edge 13 includes a chisel edge 21 including the rotational axis O1 and a thinning edge 23 extending from the chisel edge 21 toward the outer peripheral surface 9 of the body 3.

In the example illustrated in FIG. 4, the flute 15 has a thinning surface 25, and the thinning edge 23 refers to a portion of the cutting edge 13 that is positioned on a ridge line where the front end surface 11 and the thinning surface 25 intersect with each other and at which a rake angle has a negative value. The thinning edge 23 may be positioned on the rotational axis O1 side with respect to the main cutting edge 19, or may be connected to the main cutting edge 19. That is, in the front view of the body 3, the chisel edge 21, the thinning edge 23, and the main cutting edge 19 of the cutting edge 13 may be arranged in this order from the rotational axis O1 toward the outer periphery.

The chisel edge 21 refers to a portion of the cutting edge 13 that is positioned on a ridge line where a plurality of the front end surfaces 11 intersect with each other. The chisel edge 21 in the example illustrated in FIG. 4 intersects with the rotational axis O1. When viewed from the front end 3A side, the chisel edge 21 may be connected to the thinning edge 23.

The flute 15 may extend straight or may extend in a twisted manner from the cutting edge 13 toward the rear end 3B side. In the example illustrated in FIG. 2, the flute 15 extends from the cutting edge 13 toward the rear end 3B in a twisted manner about the rotational axis O1.

The above description “extends in a twisted manner” means that the flute 15 extends in a substantially twisted manner from the cutting edge 13 toward the rear end 3B side. In the example illustrated in FIG. 2, the flute 15 extends in a spiral shape. The flute 15 may have a partially untwisted portion. When the flute 15 extends in a twisted manner, a helix angle of the flute 15 is not limited to a specific value and may be set to, for example, about from 10° to 35°.

In the example illustrated in FIG. 2, when the body 3 includes a plurality of the flutes 15, one of the plurality of flutes 15 is referred to as a first flute 15A, and another one is referred to as a second flute 15B. Each of the first flute 15A and the second flute 15B is in contact with the first outer peripheral surface 9A. The first flute 15A is adjacent to the first outer peripheral surface 9A forward in the rotational direction O2. The second flute 15B is adjacent to the first outer peripheral surface 9A rearward in the rotational direction O2.

The second flute 15B may have the same configuration as the first flute 15A. That is, when the second flute 15B is rotated about the rotational axis O1, the second flute 15B may overlap the first flute 15A. Specifically, in the example illustrated in FIG. 4 and other diagrams, the first flute 15A and the second flute 15B are 180° rotationally symmetric about the rotational axis O1. In addition, a flute 15 other than the first flute 15A and the second flute 15B in the plurality of flutes 15 may have the same configuration as the first flute 15A and the second flute 15B.

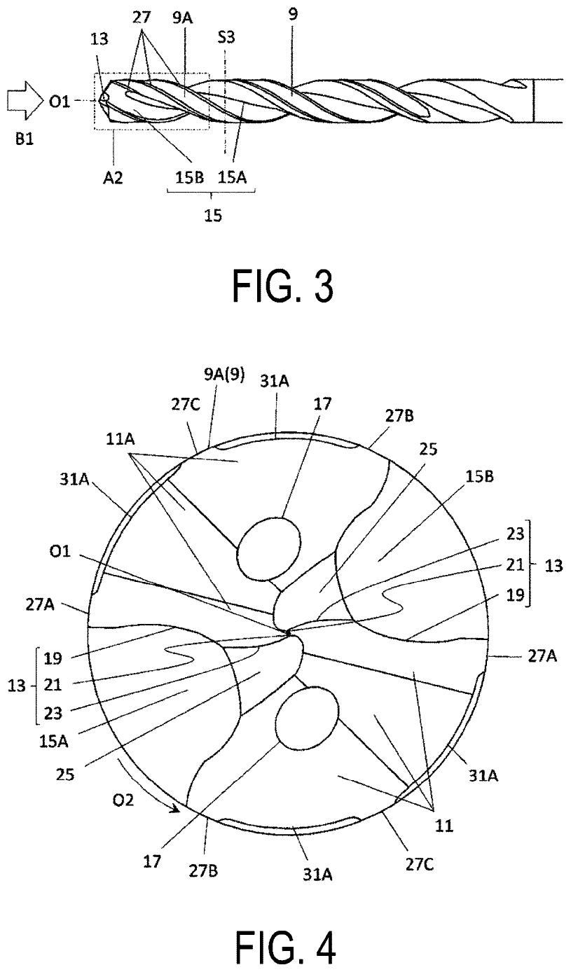

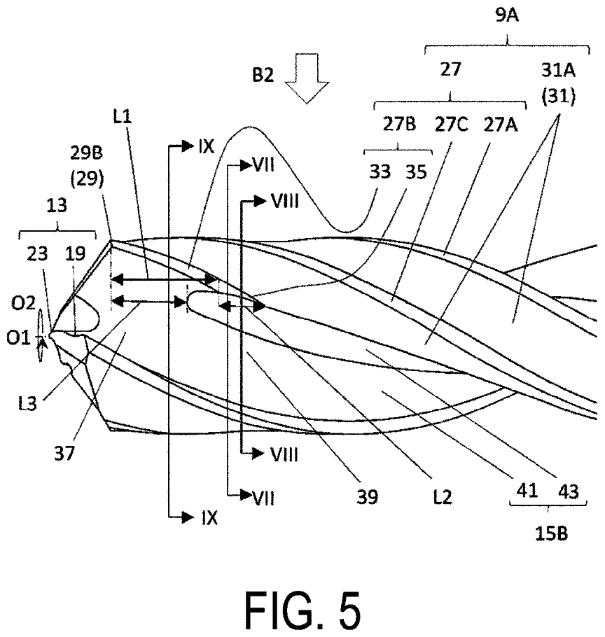

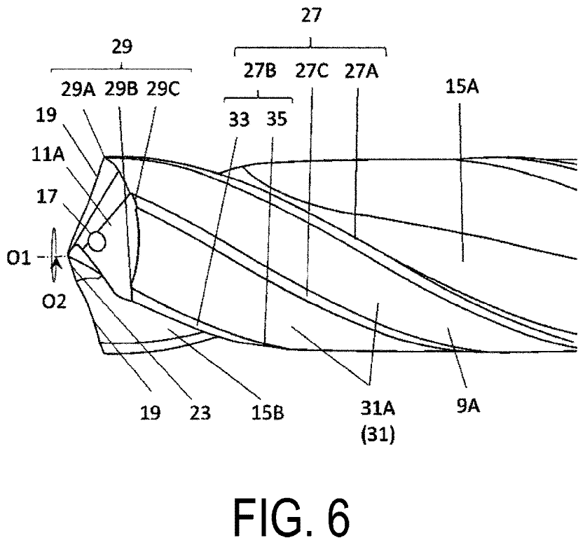

Each of FIGS. 3 and 5 is a plan view as viewed from a direction orthogonal to the rotational axis O1, and may also be referred to as a side view. As illustrated in FIGS. 3 and 5, the first outer peripheral surface 9A has a plurality of margins 27 extending from the front end 3A side toward the rear end 3B side. Each margin 27 is brought into sliding contact with an inner wall surface of a machined hole when the workpiece is machined by the cutting edge 13, and has a guide function for stabilizing the advancing direction of the drill 1. In the example illustrated in FIG. 6, a front end portion 29 of each margin 27 is in contact with the first front end surface 11A. Here, the front end portion 29 refers to a portion of each margin 27 positioned on the front end 3A side.

The first outer peripheral surface 9A has a first margin 27A extending along the first flute 15A, as one of the plurality of margins 27. In the example illustrated in FIG. 6, the first margin 27A is in contact with the first flute 15A, but no limitation is intended. The first margin 27A extends from the main cutting edge 19 toward the rear end 3B side. In addition, the first margin 27A is in contact with the main cutting edge 19. The first margin 27A is positioned at an end portion of the first outer peripheral surface 9A forward in the rotational direction O2. Below, the front end portion 29 in the first margin 27A is referred to as a first front end portion 29A.

The first outer peripheral surface 9A has a second margin 27B extending along the second flute 15B, as one of the plurality of margins 27. The second margin 27B is in contact with the second flute 15B. In the example illustrated in FIG. 5, the second margin 27B extends from the first front end surface 11A toward the rear end 3B side. The second margin 27B is positioned at an end portion of the first outer peripheral surface 9A rearward in the rotational direction O2. Below, the front end portion 29 in the second margin 27B is referred to as a second front end portion 29B.

In the example illustrated in FIGS. 5 and 6, the first outer peripheral surface 9A has a clearance 31 as a portion other than the plurality of margins 27. The first outer peripheral surface 9A has a first clearance 31A positioned between the first margin 27A and the second margin 27B. When the first outer peripheral surface 9A has a margin 27 other than the first margin 27A and the second margin 27B, the first clearance 31A may be constituted by a plurality of surface regions.

A distance from the rotational axis O1 corresponding to a radial thickness of the clearance 31 is slightly shorter than a distance from the rotational axis O1 corresponding to a radial thickness of the margin 27. Since the body 3 includes the clearance 31, an area in contact with the inner wall surface of the machined hole is suppressed, and frictional heat due to contact can be reduced. Thus, durability of the drill is improved. As a result, the drill 1 can reduce the occurrence of scratches and the like on the inner wall surface of the machined hole caused by a defect in the drill 1.

Widths of the margin 27 and the clearance 31 excluding the second margin 27B in the circumferential direction about the rotational axis O1 may be constant. In addition, the first margin 27A may be wider than the other margins 27 in the circumferential direction about the rotational axis O1. The description “the width is constant” does not necessarily mean that the width is constant, and the width as a whole may fall within a range of 95% to 105%. Thus, this does not necessarily mean that the width is constant even in subsequent descriptions that “the width is constant”.

The first margin 27A extends further to the rear end 3B side than the second margin 27B. In the example illustrated in FIG. 5, the first margin 27A is longer than the second margin 27B in a direction in which the rotational axis O1 extends.

The second margin 27B has a first region 33 positioned on the front end 3A side and a second region 35 positioned on the rear end 3B side with respect to the first region 33. The first region 33 may include the second front end portion 29B, and in the example illustrated in FIG. 5, the first region 33 is connected to the second region 35. A width of the first region 33 in the circumferential direction about the rotational axis O1 may be constant or slightly vary from the front end 3A side toward the rear end 3B side.

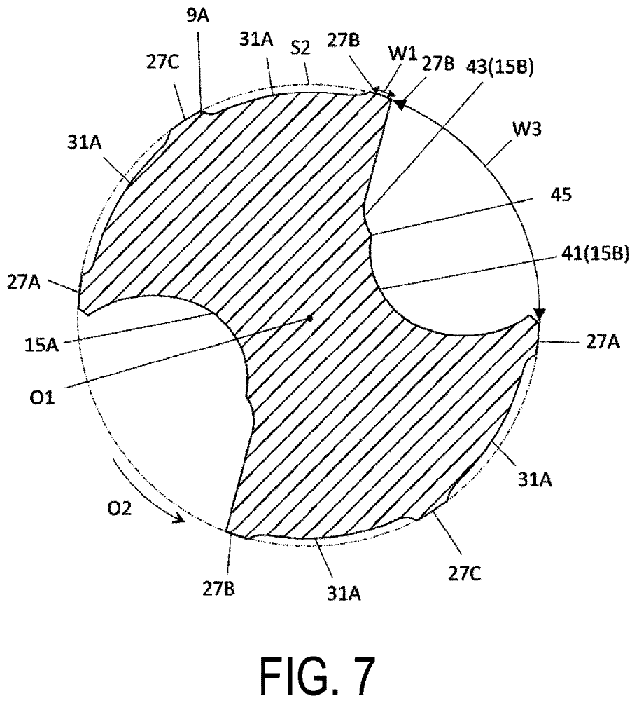

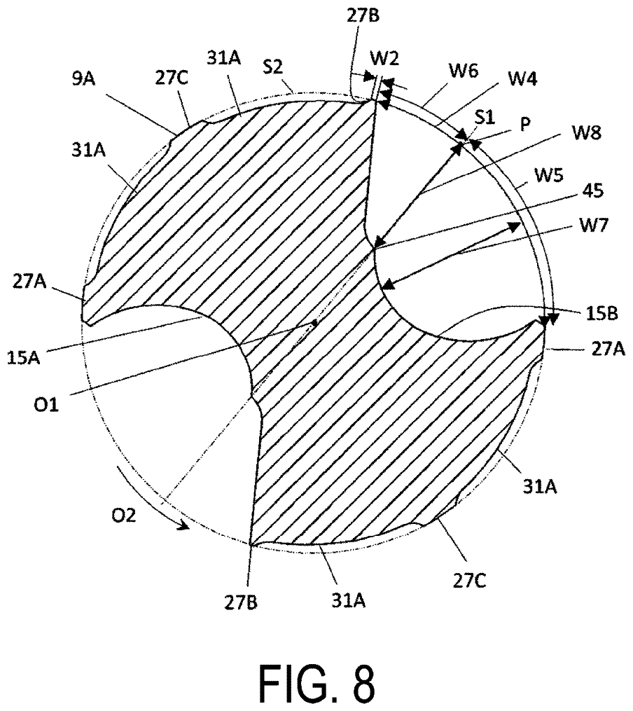

FIG. 7 is a cross-sectional view of the body 3 taken along line VII-VII illustrated in FIG. 5. The VII-VII cross section is a cross section that includes a portion of the second region 35 on the front end 3A side and is orthogonal to the rotational axis O1. FIG. 8 is a cross-sectional view of the body 3 taken along line VIII-VIII illustrated in FIG. 5. The VIII-VIII cross section is a cross section that includes a center of the second region 35 in the direction in which the rotational axis O1 extends and is orthogonal to the rotational axis O1.

A width of the second region 35 in the circumferential direction about the rotational axis O1 decreases from the front end 3A side toward the rear end 3B side. Specifically, as in the example illustrated in FIGS. 7 and 8, in the second region 35, a width in the circumferential direction of a portion positioned near the front end 3A is referred to as W1, and a width in the circumferential direction of a portion positioned near the rear end 3B is referred to as W2. When these widths W1 and W2 are compared, W1>W2 is satisfied.

In addition, as illustrated in FIG. 5, the second region 35 may have a width of 0 in the circumferential direction about the rotational axis O1 on the rear end 3B side. Below, such a case will be referred to as disappearance of the second region 35. In a configuration where the second region 35 disappears, the width in the circumferential direction of the second flute 15B connected to the second region 35 can be increased.

The second flute 15B has a first portion 37 connected to the first region 33 and a second portion 39 connected to the second region 35. In the example illustrated in FIG. 5, the first portion 37 is connected to the second portion 39. In the first flute 15A, a width of the first portion 37 in the circumferential direction about the rotational axis O1 may be constant from the front end 3A side toward the rear end 3B side. In addition, a width of the second portion 39 in the circumferential direction about the rotational axis O1 increases from the front end 3A side toward the rear end 3B side.

Specifically, as illustrated in FIGS. 7 and 8, in the second portion 39, a width in the circumferential direction of a portion positioned on the front end 3A side is referred to as W3 and a width in the circumferential direction of a portion positioned on the rear end 3B side with respect to the portion is referred to as W4. When these widths W3 and W4 are compared, W3<W4 is satisfied.

When a plurality of the margins 27 are provided on one outer peripheral surface 9, the outer peripheral surface 9 may have one of the margins 27 in the vicinity of the main cutting edge 19. With this configuration, the drill 1 can receive a machining load applied to the main cutting edge 19 at a contact portion between the margin 27 (first margin 27A) positioned near the main cutting edge 19 and the inner wall of the machined hole when machining a machined product, and stable machining can be performed.

In addition, when the first margin 27A is provided as described above, the outer peripheral surface 9 where the first margin 27A is positioned may have another margin 27 (second margin 27B) at an end portion rearward in the rotational direction O2 about the rotational axis O1. In such a case, an interval between the first margin 27A and the second margin 27B is large, that is, portions in sliding contact with the inner wall of the machined hole are distant from each other. Accordingly, the drill 1 can reduce the influence of the direction in which the machining load is applied to the cutting portion 5. Thus, the advancing direction of the drill 1 can be stabilized by each sliding contact portion.

However, when the interval between the first margin 27A and the second margin 27B is increased as described above, the proportion of the outer peripheral surface 9 occupying space in the outer surface of the cutting portion 5 increases accordingly, and thus the proportion of the flute 15 occupying space in the cutting portion 5 decreases. As a result, a discharge space for chips is reduced and the chip dischargeability is reduced.

The drill 1 according to the present embodiment includes the plurality of margins 27 on the outer peripheral surface 9 (first outer peripheral surface 9A), and the margin 27 (second margin 27B) positioned rearward of the rotational axis O1 is configured to decrease in width in the circumferential direction partway along from the front end 3A toward the rear end 3B. The width of the flute 15 (second flute 15B) in the circumferential direction about the rotational axis O1 increases in accordance with the decrease in width of the margin 27.

Since the drill 1 has the above-described configuration, the machining stability of the drill 1 can be enhanced by the first margin 27A and the second margin 27B on the front end 3A side. On the other hand, on the rear end 3B side with respect to the second margin 27B, the flute width of the second flute 15B is increased due to the space generated resulting from the decrease in width of the second margin 27B, and favorable chip dischargeability can be ensured.

Specifically, in an initial stage of machining, since the depth of the machined hole in the workpiece is shallow and an area of a portion where the margin 27 and the inner wall of the machined hole are in sliding contact with each other is small, unstable machining is likely to occur. Therefore, by providing the plurality of margins 27 on the front end 3A side of the body 3, the drill 1 can perform stable machining even in the initial stage of machining. On the other hand, in a stage where machining has progressed to some extent, chips generated by the machining become entangled with each other, and chip clogging is likely to occur in the flute. However, by making the second flute 15B wider on the rear end 3B side with respect to the second margin 27B, chip dischargeability can be improved.

The drill 1 according to the present embodiment has the above-described configuration and thus can afford both stability of machining and favorable chip dischargeability.

The first region 33 may be longer than the second region 35 in the direction in which the rotational axis O1 extends. Specifically, as in the example illustrated in FIG. 5, a length L1 of the first region 33 may be greater than a length L2 of the second region 35. In such a case, the first region 33 becomes relatively long, and the advancing direction of the drill 1 can be guided by a larger area at the second margin 27B. As a result, stable machining can be performed even in the initial stage of machining in which machining by the drill 1 is not stable.

Specifically, L1/L2 may be 1.3 or greater. In this case, machining in the initial stage of machining can be further stabilized. In addition, L1/L2 may be 5 or less. In this case, chip dischargeability at the second portion 39 of the second flute 15B is improved.

The length of the first region 33 in the direction in which the rotational axis O1 extends may be greater than a radius of the body 3. Specifically, the length L1 of the first region 33 may be longer than half of the outer diameter D of the body 3. In such a case, the first region 33 becomes longer, and the advancing direction of the drill 1 can be guided by a larger area at the second margin 27B. As a result, stable machining can be performed even in the initial stage of machining in which machining by the drill 1 is not stable.

The second flute 15B may include a main flute 41 connected to the first region 33, or may include a sub-flute 43 positioned forward of the main flute 41 in the rotational direction O2.

Whether the second flute 15B has the main flute 41 and the sub-flute 43 may be determined based on whether a protruding portion 45 is present in the second flute 15B in a cross section including the second region 35 and orthogonal to the rotational axis O1, as illustrated in FIGS. 7 and 8. In such a case, a thickness of the drill body is ensured at the protruding portion 45, rather than in a case where an integral flute is formed. Thus, the durability of the drill is improved.

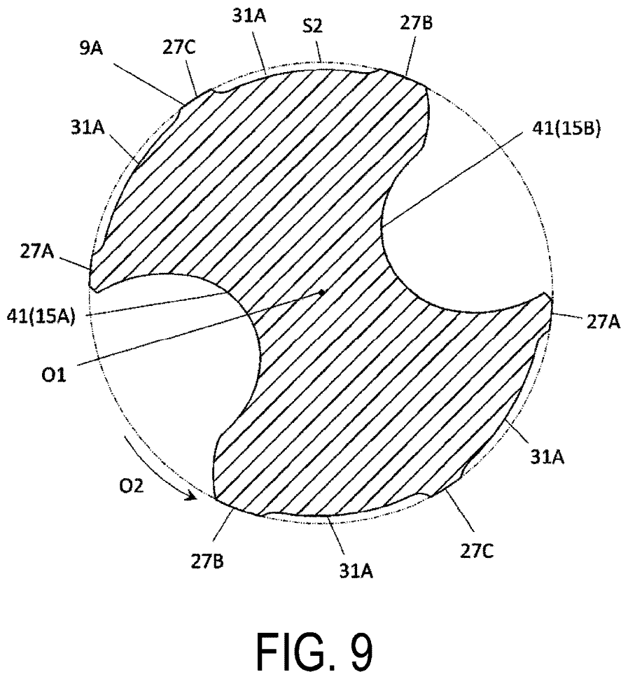

FIG. 9 is a cross-sectional view of the body 3 taken along line IX-IX illustrated in FIG. 5. The IX-IX cross section is a cross section that includes a center of the first region 33 in the direction in which the rotational axis O1 extends and is orthogonal to the rotational axis O1. As illustrated in FIGS. 5 and 9, the first region 33 may be separated from the sub-flute 43 and may be connected to the main flute 41. In addition, the second region 35 may be separated from the main flute 41 and may be connected to the sub-flute 43.

The sub-flute 43 may be positioned on the rear end 3B side with respect to the front end portion 29 of each margin 27, and in the direction in which rotational axis O1 extends, an interval L3 from the second front end portion 29B to the front end 3A side of the sub-flute 43 may be smaller than the length L1 of the first region 33. In such a case, space for chip discharge can be secured in the portion of the first portion 37 where the sub-flute 43 is positioned while making the first region 33 long. The sub-flute 43 may be formed by performing grinding, laser processing, or the like on the drill 1 including only the main flute 41.

In the circumferential direction about the rotational axis O1, a width W5 of the main flute 41 may be larger than a width W6 of the sub-flute 43. Specifically, W5/W6 may be 1.3 or greater. In the example illustrated in FIG. 8, the above-described widths are compared by evaluating in an interval from an intersection point P to an opening end of each flute, where the intersection point P is a point at which an imaginary straight line S1 passing through the top of the protruding portion 45, which is a boundary between the main flute 41 and the sub-flute 43, and the rotational axis S1 intersects with an imaginary outer peripheral circle S2 of the body 3. Since the main flute 41 contributes to chip disposal in the initial stage of machining, the above-described configuration can enhance the chip dischargeability of the drill 1 even in the initial stage of machining.

As illustrated in FIGS. 7 and 8, the main flute 41 and the sub-flute 43 each have a concave shape in a cross section perpendicular to the rotational axis O1. Specifically, the shape may be a concave curve shape. In addition, a depth W7 of the main flute 41 is larger than a depth W8 of the sub-flute 43. Specifically, W7/W8 may be 1.1 or greater. The depth of each flute refers to an interval from the deepest portion of each flute to the outer peripheral circle. Since the main flute 41 contributes to chip disposal in the initial stage of machining, the above-described configuration increases the depth of the main flute 41 and thus can enhance the chip dischargeability of the drill 1 even in the initial stage of machining.

An angle at which the second flute 15B is twisted in the circumferential direction at the first portion 37 and the second portion 39 may be smaller than 180°. Specifically, as illustrated in FIG. 3, the second margin 27B may disappear on the front end 3A side with respect to an imaginary straight line S3 that passes through a position of the second flute 15B when the second flute 15B is twisted by 180° and is orthogonal to the rotational axis O1. When the first member and the second member have the above-described configuration, the second flute 15B is wider on the front end 3A side as compared with a case where the second margin 27B disappears on the rear end 3B side with respect to the imaginary straight line S3, and favorable chip dischargeability can be ensured in the initial stage of machining.

The first outer peripheral surface 9A may include a third margin 27C positioned between the first margin 27A and the second margin 27B. The third margin 27C may extend closer to the rear end 3B than the second margin 27B. In such a case, since the advancing direction of the drill 1 is guided by the plurality of margins 27, more stable machining can be performed. Below, the front end portion 29 in the third margin 27C is referred to as a third front end portion 29C.

In the direction in which the rotational axis O1 extends, the first front end portion 29A is positioned on the front end 3A side with respect to the second front end portion 29B and the third front end portion 29C. Since the first front end portion 29A is positioned close to the main cutting edge 19, when the first front end portion 29A is positioned on the front end 3A side with respect to the second front end portion 29B and the third front end portion 29C, contact with the workpiece can be made from the cutting edge 13 at the start of machining.

In addition, in the direction in which the rotational axis O1 extends, the position of the second front end portion 29B may be the same as the position of the third front end portion 29C. The term “the same position” does not necessarily mean that the second front end portion 29B and the third front end portion 29C are present on the same line orthogonal to the rotational axis O1 or on the same cross section orthogonal to the rotational axis O1 when the drill 1 is viewed from the side. In other words, the second front end portion 29B and the third front end portion 29C may have a deviation of about +2% with respect to the length L of the body 3, with the direction in which the rotational axis O1 extends.

In the above case, the second margin 27B and the third margin 27C come into contact with the workpiece at the same time during machining. Therefore, chatter vibration is less likely to occur as compared with a case where the position of the second front end portion 29B is different from the position of the third front end portion 29C, that is, a case where the margins 27 come into contact with the workpiece in a stepwise manner.

Here, in the drill 1 according to the present embodiment, the configuration of the first margin 27A and the configuration of the second margin 27B may be reversed. For example, the width of the first margin 27A in the circumferential direction about the rotational axis O1 may decrease from the front end 3A side toward the rear end 3B side, and the second margin 27B may extend closer to the rear end 3B than the first margin 27A.

When the width of the first margin 27A in the circumferential direction decreases, the width of the first flute 15A may increase in accordance with the decrease in the width. In addition, in this case, the positions of the main flute 41 and the sub-flute 43 in the first flute 15A may also be reversed. Specifically, the first flute 15A may include the main flute 41 and the sub-flute 43 positioned rearward of the main flute 41 in the rotational direction O2, and the first margin 27A may decrease in width in the circumferential direction in a region in contact with the sub-flute 43.

However, even when the configuration of the first margin 27A and the configuration of the second margin 27B are reversed, the configuration in which the first margin 27A extends along the first flute 15A and the second margin 27B extends along the second flute 15B does not change.

The material of the body 3 includes cemented carbide alloy and cermet or the like, for example. The composition of the cemented carbide alloy includes WC—Co, WC—TiC—Co, and WC—TiC—TaC—Co, for example. Here, WC, TiC, and TaC are hard particles, and Co is a binder phase. Cermet is a sintered composite material in which a metal is combined with a ceramic component. Specifically, examples of the cermet include a titanium compound containing titanium carbide (TiC) or titanium nitride (TiN) as a main component.

The surface of the body 3 may be coated with a coating using a chemical vapor deposition (CVD) method or a physical vapor deposition (PVD) method. Examples of the composition of the coating film include titanium carbide (TiC), titanium nitride (TiN), titanium carbonitride (TiCN), alumina (Al2O3), and the like.

### Method for Manufacturing Machined Product

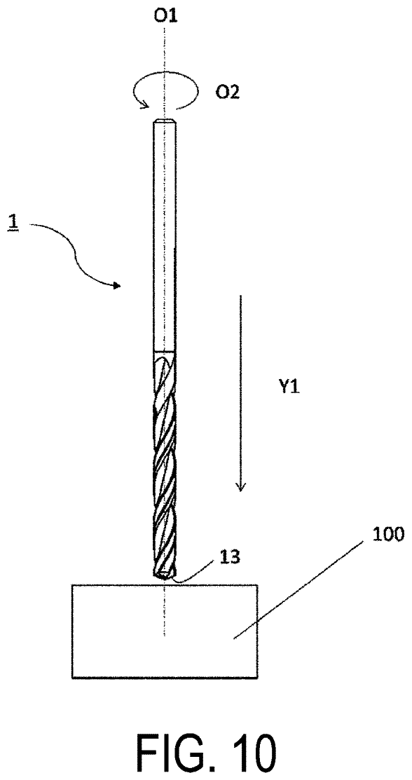

Next, a method of manufacturing a machined product according to an embodiment of the present disclosure will be described in detail with reference to an example in which the drill 1 according to the above-described embodiment is used. Hereinafter, description will be given with reference to FIGS. 10 to 12.

A method of manufacturing a machined product according to an embodiment of the present disclosure includes the steps of: (1) rotating the drill 1 about the rotational axis O1; (2) bringing the cutting edge 13 of the drill 1 that is rotating into contact with a workpiece 100; and (3) separating the drill 1 from the workpiece 100.

More specifically, first, as illustrated in FIG. 10, the drill 1 is rotated about the rotational axis O1 and moved in a direction (Y1 direction) along the rotational axis O1, thereby bringing the drill 1 relatively close to the workpiece 100.

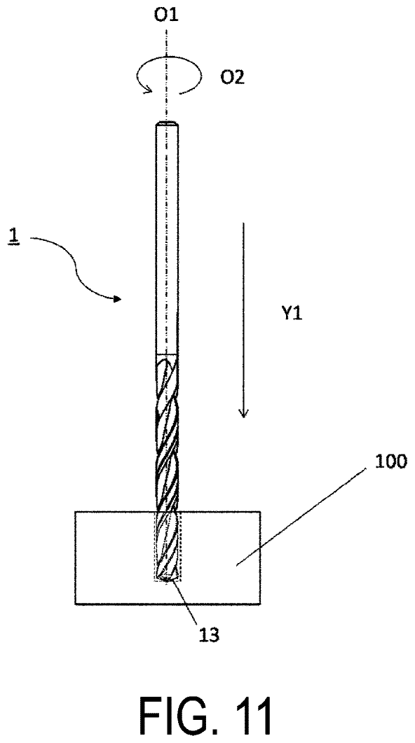

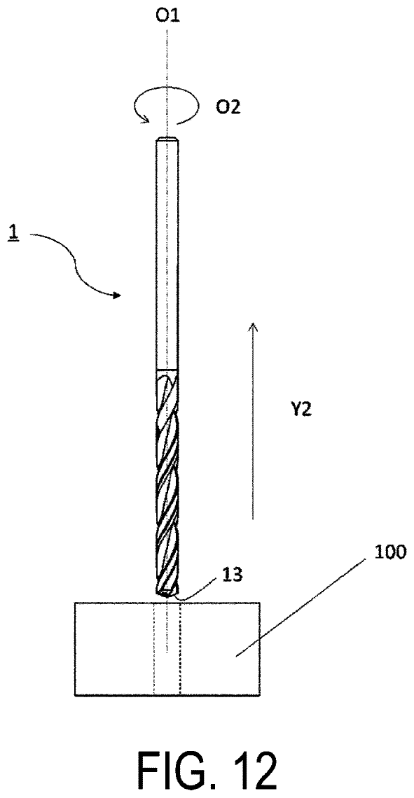

Next, as illustrated in FIG. 11, the cutting edge 13 of the drill 1 is brought into contact with the workpiece 100 to machine the workpiece 100. Then, as illustrated in FIG. 12, by moving the drill 1 in a direction Y2, the drill 1 is relatively moved away from the workpiece 100.

In the embodiment, the drill 1 is brought close to the workpiece 100 in a state where the workpiece 100 is fixed and the drill 1 is rotated about the rotational axis O1. Additionally, in FIG. 11, the workpiece 100 is machined by bringing the cutting edge 13 of the drill 1 that is rotating into contact with the workpiece 100. Additionally, in FIG. 12, the drill 1 is moved away from the workpiece 100 in a rotated state.

In the machining using the manufacturing method according to the embodiment of the present disclosure, the drill 1 is brought into contact with the workpiece 100 or the drill 1 is separated from the workpiece 100 by moving the drill 1 in each step. Naturally, the present invention is not limited to such a configuration.

For example, in the step (1), the workpiece 100 may be brought close to the drill 1. In addition, in the step (3), the workpiece 100 may be moved away from the drill 1. In the case of continuing the machining, the step of bringing the cutting edge 13 of the drill 1 into contact with a different portion of the workpiece 100 may be repeated while maintaining the state in which the drill 1 is rotated.

Typical examples of the material of the workpiece 100 include aluminum, carbon steel, alloy steel, stainless steel, cast iron, and nonferrous metal, or the like.

### REFERENCE SIGNS

1 Drill
3 Body
3A First end (Front end)
3B Second end (Rear end)
5 Cutting portion
7 Shank portion
9 Outer peripheral surface
9A First outer peripheral surface
11 Front end surface
11A First front end surface
13 Cutting edge
15 Flute
15A First flute
15B Second flute
17 Opening portion
19 Main cutting edge
21 Chisel edge
23 Thinning edge
25 Thinning surface
27 Margin
27A First margin
27B Second margin
27C Third margin
29 Front end portion
29A First front end portion
29B Second front end portion
29C Third front end portion
31 Clearance
31A First clearance
33 First region
35 Second region
37 First portion
39 Second portion
41 Main flute
43 Sub-flute
45 Protruding portion
100 Workpiece
O1 Rotational axis
O2 Rotational direction
L Length of body
L1 to L3 Length (interval)
D Outer diameter of body
W1 to W8 Width (depth)
S1 to S3 Imaginary straight line (imaginary outer peripheral circle)
P Intersection point
Y1, Y2 Movement direction

1. A drill comprising a rod-shaped body extending along a rotational axis from a first end toward a second end,
the body comprising:
a first outer peripheral surface extending from the first end toward the second end,
a cutting edge positioned on the first end side,
a first flute extending from the cutting edge toward the second end side and adjacent to the first outer peripheral surface forward in a rotational direction about the rotational axis, and
a second flute extending from the cutting edge toward the second end side and adjacent to the first outer peripheral surface rearward in the rotational direction,
the first outer peripheral surface comprising:
a first margin extending along the first flute,
a second margin extending along the second flute, and
a first clearance positioned between the first margin and the second margin, the first margin extending closer to the second end side than the second margin,
the second margin comprising:
a first region positioned on the first end side, and
a second region positioned on the second end side with respect to the first region, a width of the second region in a circumferential direction about the rotational axis decreasing from the first end side toward the second end side, and
the second flute comprising:
a first portion connected to the first region, and
a second portion connected to the second region, a width of the second portion in the circumferential direction increasing from the first end toward the second end.

2. The drill according to claim 1, wherein the first region is longer than the second region in a direction in which the rotational axis extends.

3. The drill according to claim 1, wherein a length of the first region in a direction in which the rotational axis extends is larger than a radius of the body.

4. The drill according to claim 1, wherein the second flute comprises:
a main flute connected to the first region, and
a sub-flute positioned forward of the main flute in the rotational direction, and
wherein the second region is separated from the main flute and is connected to the sub-flute.

5. The drill according to claim 1,
wherein the first flute and the second flute spirally extend from the first end toward the second end, and
an angle at which the second flute is twisted in the circumferential direction at the first portion and the second portion is smaller than 180°.

6. The drill according to claim 1,
wherein the first outer peripheral surface further comprises a third margin positioned between the first margin and the second margin, and
the third margin extends closer to the second end than the second margin.

7. The drill according to claim 6, wherein a position of a front end portion of the second margin is identical to a position of a front end portion of the third margin in a direction in which the rotational axis extends.

8. A method of manufacturing a machined product, the method comprising:
rotating the drill according to claim 1;
bringing the drill that is rotating into contact with a workpiece; and
separating the drill from the workpiece.
